(19) United States
(12) Patent Application Publication
(10) Pub. No.: US 2023/0268710 A1
(43) Pub. Date: Aug. 24, 2023

(54) GAS LASER APPARATUS AND ELECTRONIC DEVICE MANUFACTURING METHOD

(71) Applicant: Gigaphoton Inc., Tochigi (JP)

(72) Inventors: Youichi YAMANOUCHI, Oyama-shi (JP); Hiroshi UMEDA, Oyama-shi (JP); Kazuki NAGAI, Oyama-shi (JP); Takeshi UEYAMA, Oyama-shi (JP)

(73) Assignee: Gigaphoton Inc., Tochigi (JP)

(21) Appl. No.: 18/310,089

(22) Filed: May 1, 2023

Related U.S. Application Data
(63) Continuation of application No. PCT/JP2020/045982, filed on Dec. 10, 2020.

(51) Int. Cl. H01S 3/0977; H01S 3/097

(52) U.S. Cl. CPC H01S 3/0977; H01S 3/09702

(57) ABSTRACT

A gas laser apparatus according to an aspect of the present disclosure includes a main discharge circuit that supplies main discharge voltage that causes main discharge to a pair of main discharge electrodes, and a pre-ionization circuit that supplies pre-ionization voltage that causes corona discharge to a pre-ionization electrode. The main discharge circuit includes a step-up pulse transformer, a main capacitor and a switch connected to a primary side of the step-up pulse transformer, a first power source that charges the main capacitor, a first capacitor connected in parallel to a secondary side of the step-up pulse transformer, a first magnetic switch connected to the first capacitor, and a peaking capacitor connected in parallel to the first capacitor through the first magnetic switch and to the main discharge electrodes. An interval between start timings of the corona discharge and the main discharge is 30 ns to 60 ns inclusive.

### CROSS-REFERENCE TO RELATED APPLICATIONS

The present application is a continuation application of International Application No. PCT/JP2020/045982, filed on Dec. 10, 2020, the entire contents of which are hereby incorporated by reference.

### BACKGROUND

### 1. Technical Field

The present disclosure relates to a gas laser apparatus and an electronic device manufacturing method.

### 2. Related Art

Recently, in a semiconductor exposure apparatus, resolving power improvement has been requested along with miniaturization and high integration of a semiconductor integrated circuit. Thus, the wavelength of light output from an exposure light source has been shortened. Examples of a gas laser apparatus for exposure include a KrF excimer laser apparatus configured to output a laser beam having a wavelength of approximately 248 nm and an ArF excimer laser apparatus configured to output a laser beam having a wavelength of approximately 193 nm.

The KrF excimer laser apparatus and the ArF excimer laser apparatus each have a wide spectrum line width of 350 pm to 400 pm for spontaneous oscillation light. Thus, chromatic aberration occurs in some cases when a projection lens is made of a material that transmits ultraviolet such as KrF and ArF laser beams. This can lead to resolving power decrease. Thus, the spectrum line width of a laser beam output from the gas laser apparatus needs to be narrowed so that chromatic aberration becomes negligible. To narrow the spectrum line width, a line narrowing module (LNM) including a line narrowing element (for example, etalon or grating) is provided in a laser resonator of the gas laser apparatus in some cases. In the following, a gas laser apparatus that achieves narrowing of the spectrum line width is referred to as a line narrowed gas laser apparatus.

### LIST OF DOCUMENTS

### Patent Documents

Patent Document 1: Japanese Unexamined Patent Application Publication No. 11-177171

Patent Document 2: Japanese Unexamined Patent Application Publication No. 2-303083

### SUMMARY

A gas laser apparatus according to an aspect of the present disclosure includes a laser chamber into which laser gas is introduced; a pair of main discharge electrodes disposed inside the laser chamber; a pre-ionization electrode disposed inside the laser chamber; a main discharge circuit connected to the main discharge electrodes and configured to supply, to the main discharge electrodes, main discharge voltage that causes main discharge; and a pre-ionization circuit connected to the pre-ionization electrode and configured to supply, to the pre-ionization electrode, pre-ionization voltage that causes corona discharge. The main discharge circuit includes a step-up pulse transformer, a main capacitor and a switch that are connected to a primary side of the step-up pulse transformer, a first power source connected to the main capacitor and configured to charge the main capacitor, a first capacitor connected in parallel to a secondary side of the step-up pulse transformer, a first magnetic switch connected to the first capacitor, and a peaking capacitor connected in parallel to the first capacitor through the first magnetic switch and connected in parallel to the pair of the main discharge electrodes. An interval between a timing at which the corona discharge starts and a timing at which the main discharge starts is 30 ns to 60 ns inclusive.

An electronic device manufacturing method according to another aspect of the present disclosure includes generating a laser beam with a gas laser apparatus, outputs the laser beam to an exposure apparatus, and exposing a photosensitive substrate to the laser beam in the exposure apparatus to manufacture an electronic device. The gas laser apparatus includes a laser chamber into which laser gas is introduced, a pair of main discharge electrodes disposed inside the laser chamber, a pre-ionization electrode disposed inside the laser chamber, a main discharge circuit connected to the main discharge electrodes and configured to supply, to the main discharge electrodes, main discharge voltage that causes main discharge, and a pre-ionization circuit connected to the pre-ionization electrode and configured to supply, to the pre-ionization electrode, pre-ionization voltage that causes corona discharge. The main discharge circuit includes a step-up pulse transformer, a main capacitor and a switch that are connected to a primary side of the step-up pulse transformer, a first power source connected to the main capacitor and configured to charge the main capacitor, a first capacitor connected in parallel to a secondary side of the step-up pulse transformer, a first magnetic switch connected to the first capacitor, and a peaking capacitor connected in parallel to the first capacitor through the first magnetic switch and connected in parallel to the pair of main discharge electrodes. An interval between a timing at which the corona discharge starts and a timing at which the main discharge starts is 30 ns to 60 ns inclusive.

### BRIEF DESCRIPTION OF THE DRAWINGS

Embodiments of the present disclosure will be described below merely as examples with reference to the accompanying drawings.

FIG. 1 schematically illustrates an exemplary configuration of a gas laser apparatus.

FIG. 2 is a cross-sectional view of a laser chamber in the gas laser apparatus.

FIG. 3 illustrates a circuit configuration of a pulse power generation device including a pre-ionization circuit according to a comparative example.

FIG. 4 is a front view schematically illustrating the structure of a corona pre-ionization electrode.

FIG. 5 is a side view schematically illustrating the structure of the corona pre-ionization electrode.

FIG. 6 is a graph illustrating an example of the time interval between start of corona discharge and start of main discharge in the circuit configuration illustrated in FIG. 3.

FIG. 7 is a circuit diagram of a pulse power generation device including a pre-ionization circuit and a main discharge circuit applied to a gas laser apparatus according to Embodiment 1.

FIG. 8 is a graph illustrating a measurement result of laser energy for the time interval between start of the corona discharge and start of the main discharge.

FIG. 9 is a circuit diagram of a pulse power generation device including a pre-ionization circuit and a main discharge circuit applied to a gas laser apparatus according to Embodiment 2.

FIG. 10 is a graph illustrating an example of pre-ionization voltage in the circuit illustrated in FIG. 9.

FIG. 11 is a circuit diagram of a pulse power generation device including a pre-ionization circuit and a main discharge circuit applied to a gas laser apparatus according to Embodiment 3.

FIG. 12 is a graph illustrating temporal change of pre-ionization voltage and main discharge electrode voltage in the circuit illustrated in FIG. 11.

FIG. 13 is a circuit diagram of a pulse power generation device including a pre-ionization circuit and a main discharge circuit applied to a gas laser apparatus according to Embodiment 4.

FIG. 14 is a circuit diagram of a pulse power generation device including a pre-ionization circuit and a main discharge circuit applied to a gas laser apparatus according to Embodiment 5.

FIG. 15 is a graph illustrating the time interval between start of the corona discharge and start of the main discharge and corona discharge start voltage for the thickness of a dielectric pipe in the pre-ionization circuit illustrated in FIG. 3.

FIG. 16 schematically illustrates an exemplary configuration of an exposure apparatus.

### DESCRIPTION OF EMBODIMENTS

### <Contents>

1. Gas laser apparatus
   1.1 Configuration
   1.2 Operation
      1.2.1 Overview
      1.2.2 Details of operation
   1.3 Other
2. Pulse power generation device according to comparative example
   2.1 Configuration
   2.2 Operation
   2.3 Problem
3. Embodiment 1
   3.1 Configuration
   3.2 Operation
   3.3 Effect
   3.4 Modification
4. Embodiment 2
   4.1 Configuration
   4.2 Operation
   4.3 Effect
5. Embodiment 3
   5.1 Configuration
   5.2 Operation
   5.3 Effect
6. Embodiment 4
   6.1 Configuration
   6.2 Operation
   6.3 Effect
7. Embodiment 5
   7.1 Configuration
   7.2 Operation
   7.3 Effect
8. Embodiment 6
   8.1 Configuration
   8.2 Operation
   8.3 Effect
9. Electronic device manufacturing method
10. Other

Embodiments of the present disclosure will be described below in detail with reference to the accompanying drawings. The embodiments described below are examples of the present disclosure, and do not limit the contents of the present disclosure. Not all configurations and operations described in each embodiment are necessarily essential as configurations and operations of the present disclosure. Components identical to each other are denoted by an identical reference sign, and duplicate description thereof will be omitted.

1. Gas Laser Apparatus

1.1 Configuration

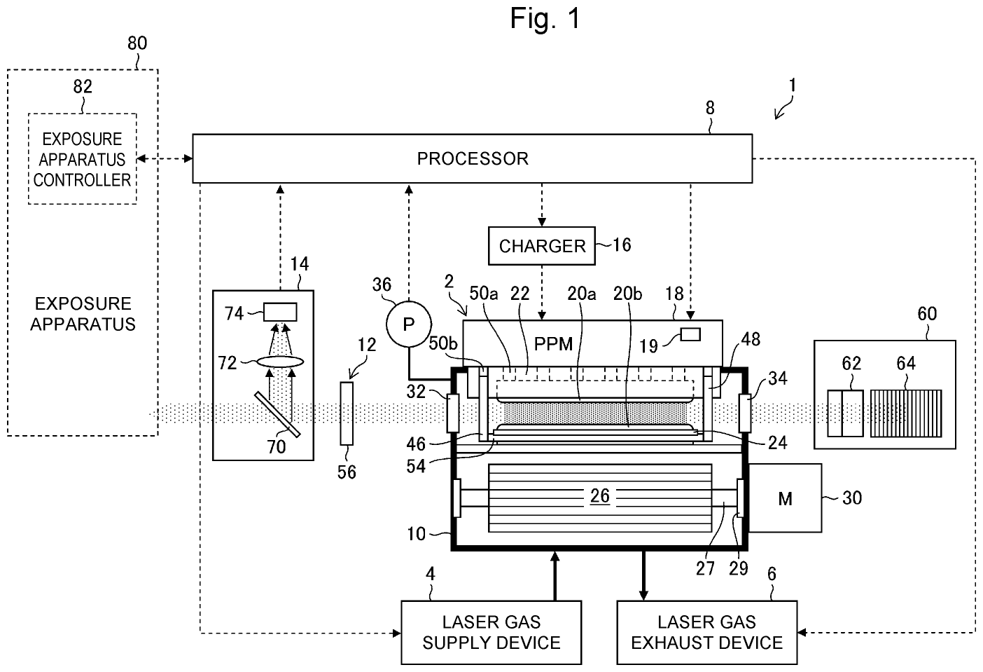

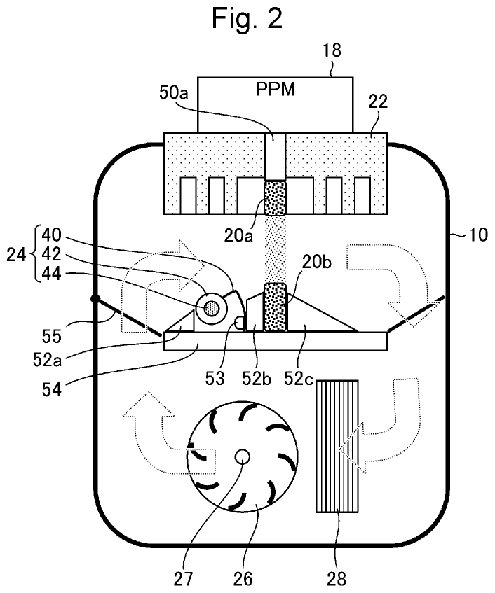

FIG. 1 schematically illustrates an exemplary configuration of a gas laser apparatus 1. FIG. 2 is a cross-sectional view of a laser chamber 10 in the gas laser apparatus 1. The gas laser apparatus 1 includes a laser oscillator system 2, a laser gas supply device 4, a laser gas exhaust device 6, and a processor 8. The laser oscillator system 2 includes the laser chamber 10, a laser resonator 12, a power monitor 14, a charger 16, and a pulse power module (PPM) 18.

The laser chamber 10 includes a pair of main discharge electrodes 20a and 20b, an electrical insulator 22, a corona pre-ionization electrode 24, a cross-flow fan 26, a heat exchanger 28, a motor 30, two windows 32 and 34 through which light from the laser resonator 12 transmits, and a pressure sensor 36. The main discharge electrodes 20a and 20b, the corona pre-ionization electrode 24, the cross-flow fan 26, and the heat exchanger 28 are disposed inside the laser chamber 10.

The corona pre-ionization electrode 24 includes a pre-ionization outer electrode 40, a dielectric pipe 42, and a pre-ionization inner electrode 44. The pre-ionization outer electrode 40 and the pre-ionization inner electrode 44 may each include a fixed plate, a ladder portion, and a non-illustrated contact plate portion. The material of these electrodes may be a metallic material containing copper as a primary component and may be, for example, oxygen-free copper, phosphor bronze, or brass. The dielectric pipe 42 is disposed near the main discharge electrode 20b with fixation pipes 46 and 48 interposed therebetween. The material of the dielectric pipe 42 may be, for example, alumina ceramic (Al₂O₃).

The pre-ionization inner electrode 44 has a cylindrical rod structure and is connected to a high-voltage side of the PPM 18 through a feed-through 50b and the fixation pipes 46 and 48. The pre-ionization outer electrode 40 is fixed to a guide 52b on an electrode holder 54 by a bolt 53 such that predetermined force is applied to a distal end of the contact plate portion. The pre-ionization outer electrode 40 is grounded.

The main discharge electrode 20b is fixed to the electrode holder 54 and connected to the grounded laser chamber 10 through the electrode holder 54 and a wire 55. Guides 52a, 52b, and 52c that rectify laser gas are disposed on the electrode holder 54. The PPM 18 includes a non-illustrated charge capacitor and is connected to the main discharge electrode 20a through a feed-through 50a. The PPM 18 includes a switch 19 for causing discharge from the main discharge electrode 20a.

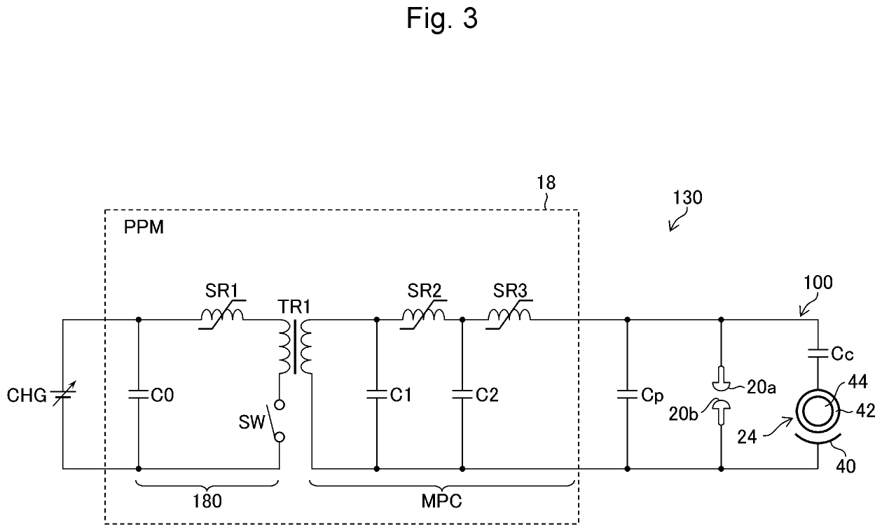

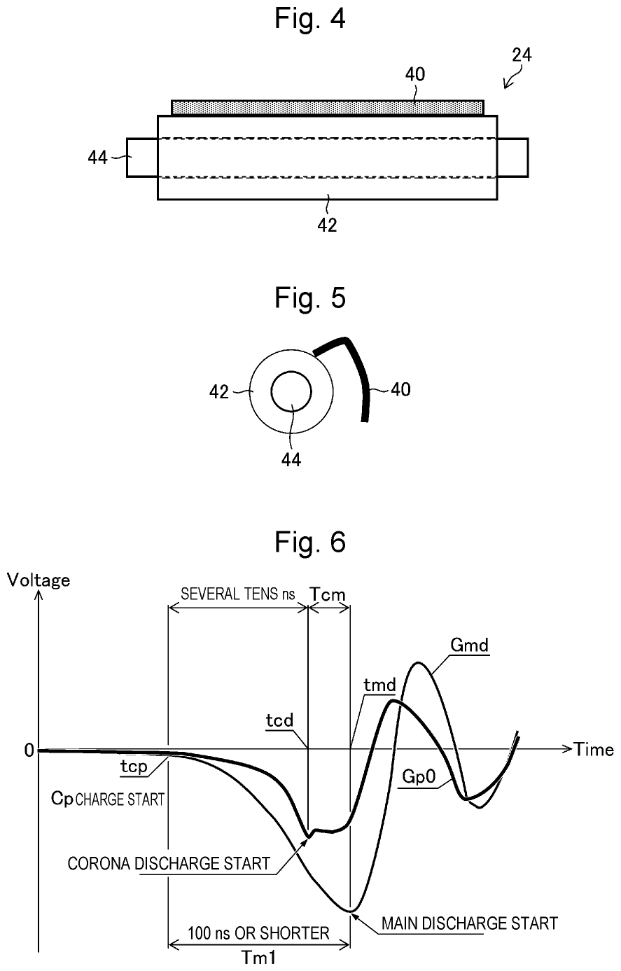

The charger 16 is connected to the charge capacitor of the PPM 18. Charge and discharge circuits will be described in detail with reference to FIGS. 3 and 4. Pulse voltage generated by the PPM 18 is applied to the main discharge electrode 20b through the laser chamber 10, the wire 55, and the electrode holder 54.

The laser chamber 10 is disposed on the optical path of the laser resonator 12. The laser resonator 12 includes an output coupler (OC) 56 and an LNM 60. The LNM 60 includes a prism 62 that enlarges a beam, and a grating 64. The grating 64 is disposed in Littrow arrangement such that the incident angle of a beam matches the diffracting angle thereof. The OC 56 is a partially reflective mirror coated with a multi-layered film that reflects part of a laser beam generated in the laser chamber 10 and transmits the other part.

The power monitor 14 is a detector configured to detect pulse energy and includes a beam splitter 70, a light condensing lens 72, and an optical sensor 74, the beam splitter 70 being disposed on the optical path of a laser beam output from the OC 56.

Laser gas introduced into the laser chamber 10 may be, for example, Ar or Kr as rare gas, F₂ gas as halogen gas, Ne or He as buffer gas, or mixed gas thereof.

The laser gas supply device 4 includes a valve and a non-illustrated flow rate control valve. The laser gas supply device 4 is connected to a non-illustrated gas tank containing the laser gas. The laser gas exhaust device 6 includes a non-illustrated valve and a discharge pump.

The motor 30 is a power source of the cross-flow fan 26. A rotational shaft 27 of the cross-flow fan 26 is supported to the laser chamber 10 through a magnetic bearing 29.

The processor 8 functions as a controller of the gas laser apparatus 1. The processor 8 is a processing device including a storage device storing a control program and a central processing unit (CPU) configured to execute the control program. The processor 8 is specially configured or programmed to execute various kinds of processing included in the present disclosure. The storage device is a non-transitory computer-readable medium as a tangible entity and includes, for example, a memory that is a main storage device and a storage that is an auxiliary storage device. The computer-readable medium may be, for example, a semiconductor memory, a hard disk drive (HDD) device, a solid-state drive (SSD) device, or a combination of a plurality of these devices.

1.2 Operation

1.2.1 Overview

When high-voltage pulse is applied from the PPM 18 to the main discharge electrodes 20a and 20b and voltage between the main discharge electrodes 20a and 20b reaches a certain value (breakdown voltage), insulation breakdown occurs to the laser gas between the main discharge electrodes 20a and 20b and main discharge starts. A laser medium is excited by the main discharge. The gas laser apparatus 1 performs pulse oscillation through repetition of the main discharge and outputs a laser beam of pulsed light.

The PPM 18 generates the high-voltage pulse to be applied to the main discharge electrodes 20a and 20b, causes discharge in the laser chamber 10, and excites the laser gas.

1.2.2 Details of Operation

The laser gas introduced into the laser chamber 10 is circulated in the laser chamber 10 by the cross-flow fan 26. The laser gas is rectified by tilted surfaces of the guides 52a, 52b, and 52c and supplied to a discharge space. The flow speed of the laser gas passing through the discharge space is improved by the rectification, and thus a discharge product generated in the discharge space can be efficiently removed from the discharge space. As a result, arc discharge due to the discharge product can be suppressed.

The processor 8 receives a target pulse energy Et and an oscillation trigger signal from an exposure apparatus controller 82 mounted on an exposure apparatus 80. The processor 8 sets predetermined charge voltage (Vhv) to the charger 16 so that the target pulse energy Et is obtained. Then, the processor 8 operates the switch 19 in the PPM 18 in synchronization with the oscillation trigger signal to apply high voltage between the pre-ionization outer electrode 40 and the pre-ionization inner electrode 44 of the corona pre-ionization electrode 24 and between the main discharge electrodes 20a and 20b.

As a result, first, corona discharge occurs at the corona pre-ionization electrode 24 and discharge ultraviolet light (UV light) is generated. The laser gas between the main discharge electrodes 20a and 20b is pre-ionized when irradiated with the UV light. Thereafter, the main discharge occurs between the main discharge electrodes 20a and 20b and the laser gas is excited. Light emitted from the excited laser gas reaches laser oscillation through reciprocation inside the laser resonator 12. This laser beam reciprocating inside the laser resonator 12 is subjected to line narrowing by the prism 62 and the grating 64, and the line-narrowed laser beam is output from the OC 56.

Part of the laser beam output from the OC 56 is incident on the power monitor 14, is partially reflected by the beam splitter 70, and passes through the light condensing lens 72, and accordingly, pulse energy E of the laser beam is detected by the optical sensor 74. The laser beam having transmitted through the beam splitter 70 is incident on the exposure apparatus 80.

The processor 8 stores at least one of the charge voltage Vhv in this case and the pulse energy E of the output laser beam. The processor 8 performs feedback control of the charge voltage Vhv based on difference ΔE between the target pulse energy Et and the actually output pulse energy E so that the pulse energy E of the output laser beam becomes equal to the target pulse energy Et.

When the charge voltage Vhv becomes higher than the maximum value of an allowable range, the processor 8 controls the laser gas supply device 4 to supply the laser gas into the laser chamber 10 until predetermined pressure is reached. When the charge voltage Vhv becomes lower than the minimum value of the allowable range, the processor 8 controls the laser gas exhaust device 6 to discharge the laser gas from the laser chamber 10 until predetermined pressure is reached.

1.3 Other

The gas laser apparatus is not necessarily limited to a line narrowed laser apparatus but may be a laser apparatus configured to output spontaneous oscillation light. For example, a high reflectance mirror may be disposed in place of the LNM 60.

The gas laser apparatus is an excimer laser apparatus in the example illustrated FIG. 1 but may be, for example, an F₂ laser apparatus that uses laser gas containing fluorine gas and buffer gas.

2. Pulse Power Generation Device According to Comparative Example

2.1 Configuration

FIG. 3 illustrates a circuit configuration of a pulse power generation device 130 including a pre-ionization circuit 100 according to a comparative example. The comparative example of the present disclosure is an example that the applicant recognizes as known only by the applicant, but is not a publicly known example that is recognized by the applicant.

The PPM 18 includes three magnetic switches SR1, SR2, and SR3 made of saturable reactor, and a two-stage magnetic pulse compression circuit MPC using a step-up pulse transformer TR1. A switching circuit 180 including a main capacitor C0, the magnetic switch SR1, and a solid switch SW is configured on the primary side of the step-up pulse transformer TR1.

The main capacitor C0 is connected to a direct-current charger CHG. The solid switch SW is a semiconductor switching element such as an insulated gate bipolar transistor (IGBT). The solid switch SW turns on and off based on a control signal from the processor 8. The control signal that turns on the solid switch SW is referred to as an ON signal. The direct-current charger CHG and the solid switch SW correspond to the charger 16 and the switch 19, respectively, in FIG. 1.

The magnetic switch SR1 is provided to reduce a switching loss at the solid switch SW and also referred to as a magnetic assist.

A first capacitor C1, the magnetic switch SR2 at a first stage, a second capacitor C2, and the magnetic switch SR3 at a second stage are connected on the secondary side of the step-up pulse transformer TR1 and constitute the two-stage magnetic pulse compression circuit MPC. The first capacitor C1 is connected in parallel to the secondary side of the step-up pulse transformer TR1. The second capacitor C2 is connected in parallel to the first capacitor C1 through the magnetic switch SR2. The magnetic switch SR3 is connected in series to the magnetic switch SR2, and the second capacitor C2 is connected between the magnetic switch SR2 and the magnetic switch SR3.

The main discharge electrodes 20a and 20b and a peaking capacitor Cp are connected in parallel to an output terminal of the PPM 18, and a series circuit of a pre-ionization capacitor Cc and the pre-ionization corona pre-ionization electrode 24 for pre-ionization is connected in parallel to the main discharge electrodes 20a and 20b.

FIGS. 4 and 5 illustrate the structure of the corona pre-ionization electrode 24. FIG. 4 is a front view, and FIG. 5 is a side view. The corona pre-ionization electrode 24 includes a dielectric (the dielectric pipe 42) having a pipe shape, the pre-ionization inner electrode 44 having a cylindrical shape and disposed inside the dielectric pipe 42, and the pre-ionization outer electrode 40 having a plate shape and disposed outside the dielectric pipe 42.

Note that although a dielectric having a plate shape is used in Patent Document 1, use of a dielectric having a pipe shape is the main stream nowadays after almost 20 years since publication of Patent Document 1. Since the performance of a pulse power generation device is improved as compared to the time of publication of Patent Document 1, it is thought that an optimum time interval between start of the corona discharge and start of the main discharge is shorter than at the time of publication of Patent Document 1.

2.2 Operation

The solid switch SW turns on while the main capacitor C0 is charged by the direct-current charger CHG. Thereafter, when the time integral value of charge voltage Vc0 of the main capacitor C0 on both ends of the magnetic switch SR1 reaches a threshold value determined by characteristics of the magnetic switch SR1, the magnetic switch SR1 saturates and turns on and current flows through a loop of the main capacitor C0, the magnetic switch SR1, a primary-side winding wire of the step-up pulse transformer TR1, and the solid switch SW. Simultaneously, current flows through a loop of a secondary-side winding wire of the step-up pulse transformer TR1 and the first capacitor C1, and electric charge stored in the main capacitor C0 transitions and charges the first capacitor C1.

When the first capacitor C1 is charged and the time integral value of voltage Vc1 of the first capacitor C1 reaches a threshold value determined by characteristics of the magnetic switch SR2, the magnetic switch SR2 saturates and turns on. Accordingly, current flows through a loop of the first capacitor C1, the second capacitor C2, and the magnetic switch SR2, and electric charge stored in the first capacitor C1 transitions and charges the second capacitor C2.

Thereafter, when the time integral value of voltage Vc2 of the second capacitor C2 reaches a threshold value determined by characteristics of the magnetic switch SR3, the magnetic switch SR3 saturates and turns on. Accordingly, current flows through a loop of the second capacitor C2, the peaking capacitor Cp, and the magnetic switch SR3, and electric charge stored in the second capacitor C2 transitions and charges the peaking capacitor Cp.

When the peaking capacitor Cp is charged and voltage Vcp of the peaking capacitor Cp reaches a certain value (breakdown voltage) Vb, the main discharge starts between the main discharge electrodes 20a and 20b in the laser chamber 10, the laser medium is excited by the main discharge, and a laser beam is generated. Voltage that causes the main discharge between the main discharge electrodes 20a and 20b is referred to as main discharge voltage.

Right before the main discharge starts, the corona discharge occurs when terminal voltage of the pre-ionization corona pre-ionization electrode 24 for pre-ionization increases to corona discharge start voltage. Then, discharge ultraviolet light radiates to the main discharge electrodes 20a and 20b and a main discharge space and ionizes gas in the main discharge space by photoionization, photoelectric effect, or the like. Accordingly, initial electrons that initiate the main discharge scatter in the main discharge space. Thus, stable glow discharge can occur in the main discharge space when the main discharge is started.

FIG. 6 illustrates an example of a time interval Tcm between start of the pre-ionization (corona discharge) and start of the main discharge in the circuit configuration illustrated in FIG. 3. In FIG. 6, the horizontal axis represents time, and the vertical axis represents voltage. FIG. 6 includes graph Gp0 of pre-ionization voltage and graph Gmd of main discharge electrode voltage. The pre-ionization voltage is voltage applied to the corona pre-ionization electrode 24. The main discharge electrode voltage is voltage applied to the main discharge electrodes 20a and 20b.

In FIG. 6, a timing tcp is the start timing of charging of the peaking capacitor Cp. A timing tcd is the start timing of the corona discharge. A timing tmd is the start timing of the main discharge.

2.3 Problem

In a KrF laser apparatus, an optimum condition exists for the time interval Tcm between start of the corona discharge as pre-ionization and start of the main discharge, and sufficient laser energy is not obtained when the interval is too short or too long. The time interval Tcm in the comparative example illustrated in FIG. 3 is, for example, 14 ns to 29 ns.

In a KrF laser apparatus, it is desirable that rising of the main discharge electrode voltage is fast for improved laser efficiency, and thus the inductance of a circuit constituted by the second capacitor C2, the magnetic switch SR3, and the peaking capacitor Cp is designed to be minimum. As a result, a time interval Tm1 between the start (timing tcp) of charging of the peaking capacitor Cp and the start (timing tmd) of the main discharge is shorter than 100 ns. Note that the laser efficiency is the ratio of laser output relative to energy input to the laser chamber 10. The energy input to the laser chamber 10 may be interpreted as energy output from the PPM 18. Accordingly, the laser efficiency can be expressed as “laser output”/“energy input to the laser chamber 10”.

The start timing tcd of the corona discharge as pre-ionization is desirably earlier than the start timing of the main discharge so that the above-described optimum time interval Tcm can be ensured. However, there is a problem as described below.

Specifically, high voltage is applied to a circuit constituted by the second capacitor C2, the magnetic switch SR3, and the corona pre-ionization electrode 24, and thus there is a structural constraint that sufficient distance needs to be provided to insulate this high-voltage part from a ground (GND) voltage level side. Accordingly, unremovable floating inductance occurs to the circuit, and several tens ns elapses between start of charging of the peaking capacitor Cp and start of the corona discharge. Thus, when the time between start of charging of the peaking capacitor Cp and start of the corona discharge is minimized, the time until start of the main discharge is minimized as well. As a result, the time interval Tcm between start of the corona discharge and start of the main discharge cannot be increased, and thus it is difficult to obtain the time interval Tcm at an optimum condition in some cases.

3. Embodiment 1

3.1 Configuration

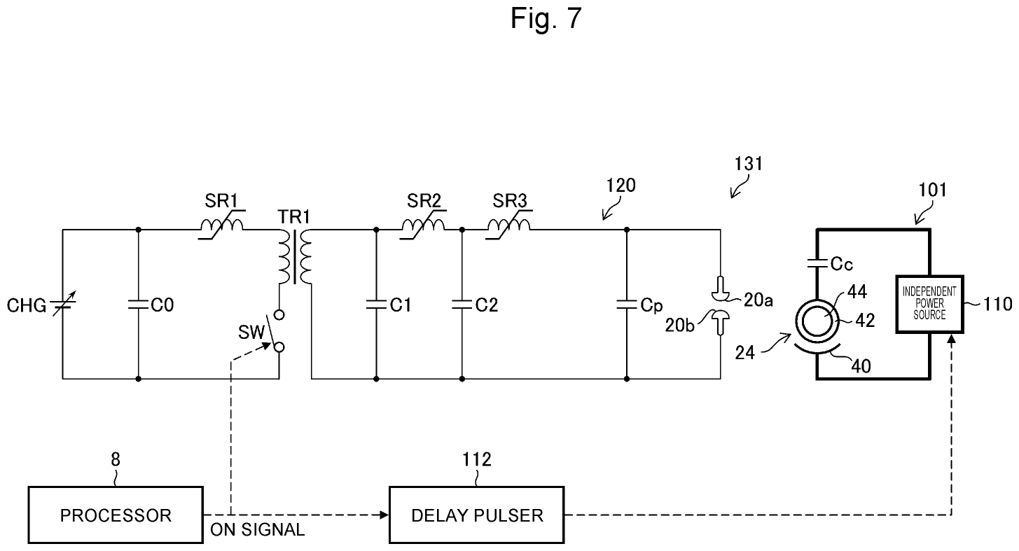

FIG. 7 is a circuit diagram of a pulse power generation device 131 including a pre-ionization circuit 101 and a main discharge circuit 120 applied to the gas laser apparatus 1 according to Embodiment 1. Description will be made on the difference of the configuration illustrated in FIG. 7 from the configuration illustrated in FIG. 3.

As illustrated in FIG. 7, the pulse power generation device 131 used in Embodiment 1 has a configuration in which the corona pre-ionization electrode 24 is separated from the main discharge circuit 120 and the corona pre-ionization electrode 24 is connected to an independent power source 110 instead of the main discharge circuit 120. The ON signal from the processor 8, which controls the solid switch SW of the main discharge circuit 120, is input to the independent power source 110 through a delay pulser 112. The other configuration may be the same as in FIG. 3.

The solid switch SW is an example of a “switch” in the present disclosure. The direct-current charger CHG is an example of a “first power source” in the present disclosure. The independent power source 110 is an example of a “second power source” in the present disclosure. The magnetic switch SR2 is an example of a “first magnetic switch” in the present disclosure. The magnetic switch SR3 is an example of a “second magnetic switch” in the present disclosure. The corona pre-ionization electrode 24 is an example of a “pre-ionization electrode” in the present disclosure. The dielectric pipe 42 is an example of a “dielectric having a pipe shape” in the present disclosure. The pre-ionization inner electrode 44 is an example of an “internal electrode” in the present disclosure. The pre-ionization outer electrode 40 is an example of an “external electrode” in the present disclosure.

3.2 Operation

The time interval Tcm between start of the corona discharge and start of the main discharge can be optionally set by setting a delay time for the ON signal in the delay pulser 112.

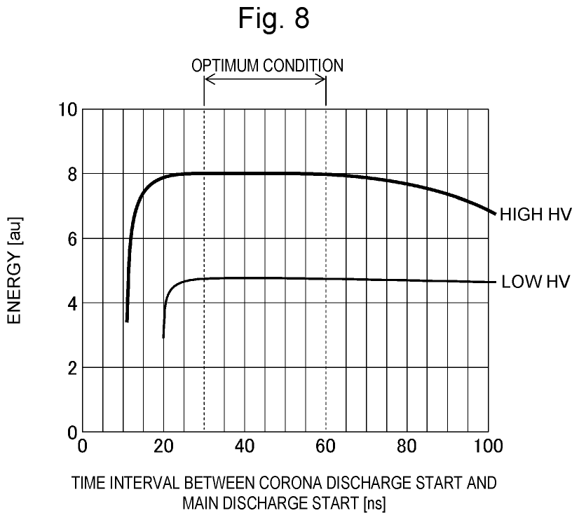

FIG. 8 is a graph illustrating a measurement result of laser energy for the time interval Tcm between start of the corona discharge and start of the main discharge. The horizontal axis represents the time interval Tcm between start of the corona discharge and start of the main discharge, and the vertical axis represents laser energy. When main discharge voltage applied between the main discharge electrodes 20a and 20b is referred to as “HV”, the normal operation range of HV is, for example, approximately 70% to 95% of the maximum value.

As a specific example, in a KrF laser apparatus having output pulse energy of 10 mJ, 70% of HV assumed for device usage, which is lower limit voltage in the normal operation range of HV is referred to as “low HV”, and 95% of HV assumed for device usage, which is upper limit voltage in the normal operation range of HV is referred to as “high HV”.

The measurement result of laser energy as illustrated in FIG. 8 is obtained when the time interval Tcm between start of the corona discharge and start of the main discharge is changed under a low HV condition and a high HV condition. As illustrated in FIG. 8, the time interval of 30 ns to 60 ns inclusive is optimum to obtain maximum laser energy under either of the low HV condition and the high HV condition.

Note that the optimum condition includes a range (for example, approximately 25 ns) shorter than 30 ns when HV is high, and the optimum condition includes a range (for example, 80 ns to 100 ns or higher) longer than 60 ns when HV is low. The optimum condition for the time interval Tcm between start of the corona discharge and start of the main discharge is 30 ns to 60 ns inclusive but does not include 25 ns nor 80 ns for the following reason. Specifically, as illustrated in FIG. 8, laser energy is slightly lower at 25 ns for low HV and at 80 ns for high HV. Thus, the optimum condition of 25 ns to 80 ns is not appropriate for both HV conditions.

As described above, the normal operation range of HV is approximately 70% to 95% of the maximum value. Moreover, the normal operation range of gas pressure in the laser chamber 10 is approximately 220 kPa to 360 kPa. In these normal operation ranges, the optimum condition of the time interval Tcm between start of the corona discharge and start of the main discharge is 30 ns to 60 ns inclusive as illustrated in FIG. 8.

The processor 8 provides the ON signal to the solid switch SW at a certain timing, thereby causing the main discharge. The delay pulser 112 is set with a delay time for providing the ON signal to the independent power source 110 to cause the corona discharge at a timing earlier than the start timing of the main discharge by 30 ns to 60 ns.

The start timing of the main discharge based on the ON signal from the processor 8 is an example of a “first timing” in the present disclosure, and the start timing of the corona discharge based on the ON signal delayed at the delay pulser 112 is an example of a “second timing” in the present disclosure.

3.3 Effect

According to Embodiment 1, the time interval Tcm between start of the corona discharge and start of the main discharge can be set to the optimum condition irrespective of circuit parameters. Accordingly, maximum laser energy can be obtained.

3.4 Modification

The magnetic switch SR1 is disposed to reduce a switching loss at the solid switch SW, and thus the circuit functions without the magnetic switch SR1.

The second capacitor C2 and the magnetic switch SR3 are disposed to achieve multi-stage pulse compression, and thus the circuit functions without these elements. Alternatively, a plurality of stages may be added.

The pre-ionization capacitor Cc is a voltage-dividing capacitor for preventing insulation breakdown due to excessive voltage application to the corona pre-ionization electrode 24. The circuit functions without the pre-ionization capacitor Cc when the corona pre-ionization electrode 24 has sufficiently high dielectric strength.

Functions of the delay pulser 112 may be implemented on the processor 8. Functions of the processor 8 and the delay pulser 112 may be implemented by a plurality of processors.

4. Embodiment 2

4.1 Configuration

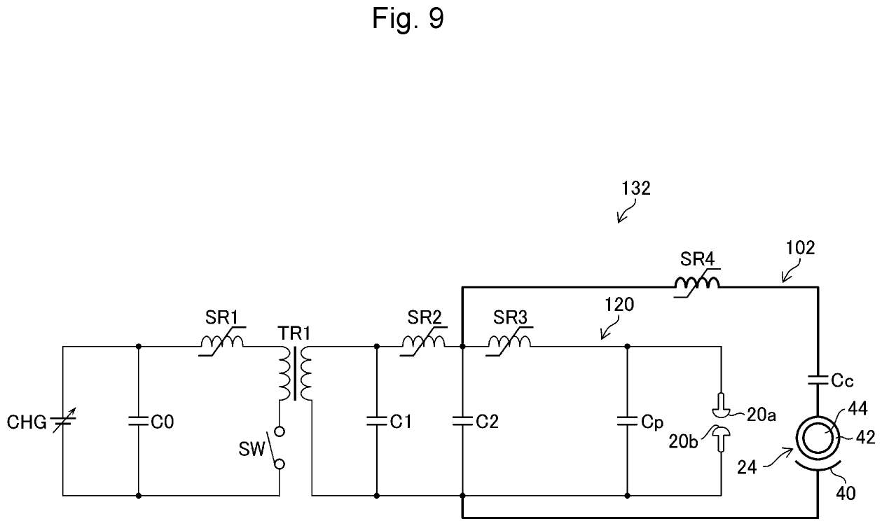

FIG. 9 is a circuit diagram of a pulse power generation device 132 including a pre-ionization circuit 102 and the main discharge circuit 120 applied to the gas laser apparatus 1 according to Embodiment 2. Description will be made on the difference of the configuration illustrated in FIG. 9 from the configuration illustrated in FIG. 3.

In the pulse power generation device 132 used in Embodiment 2, the pre-ionization circuit 102 is connected in parallel to the second capacitor C2 as illustrated in FIG. 9. A magnetic switch SR4 is connected to the pre-ionization circuit 102 in series with the pre-ionization capacitor Cc and the corona pre-ionization electrode 24. The other configuration may be the same as in FIG. 3. The magnetic switch SR4 is an example of a “third magnetic switch” in the present disclosure.

4.2 Operation

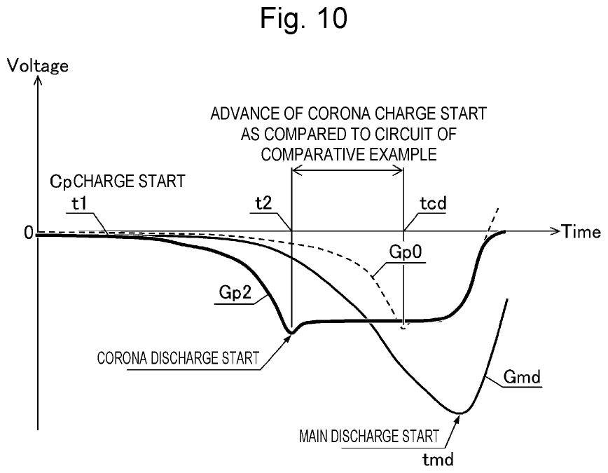

FIG. 10 is a graph illustrating an example of pre-ionization voltage in the circuit illustrated in FIG. 9. Graph Gp2 in the drawing illustrates the pre-ionization voltage. Graph Gp0 illustrated with a dashed line in the drawing illustrates the pre-ionization voltage of the circuit (FIG. 3) according to the comparative example. Graph Gmd in the drawing illustrates the main discharge electrode voltage.

In FIG. 10, charging of the peaking capacitor Cp is started at timing t1. Timing t2 at which graph Gp2 has a bottom value is the start timing of the corona discharge. The start timing t2 of the corona discharge in the pulse power generation device 132 according to Embodiment 2 is earlier than the start timing tcd of the corona discharge in the pulse power generation device 130 according to the comparative example.

The pulse power generation device 132 according to Embodiment 2 can start the corona discharge at a timing earlier than the timing of the corona discharge by the pulse power generation device 130 according to the comparative example by a time taken for energy transfer through the second capacitor C2, the magnetic switch SR3, and the peaking capacitor Cp.

When the start timing t2 of the corona discharge is too early, it is possible to delay start of the corona discharge by providing the magnetic switch SR4. In a case in which the magnetic switch SR4 is provided, it is possible to advance start of the corona discharge (refer to FIG. 10) by designing a shorter block time T for the magnetic switch SR4 than for the magnetic switch SR3, the block time T being calculated by N×ΔB×S/V where N represents the number of turns of a magnetic core, ≢6B represents change in the magnetic flux density of the magnetic core, S represents the cross-sectional area of the magnetic core, and V represents voltage between both ends of the magnetic switch. Note that the block time T is a time that elapses until the magnetic core is saturated.

Moreover, since the block time T can be changed based on the values of N, ΔB, and S, it is possible to start the corona discharge at a desired timing by designing the magnetic switch SR4 accordingly.

As described above, circuit parameters are designed to achieve such an optimum condition that the time interval Tcm between the start timing t2 of the corona discharge and the start timing tmd of the main discharge is 30 ns to 60 ns inclusive.

4.3 Effect

According to Embodiment 2, the time interval Tcm between start of the corona discharge and start of the main discharge can be set to the optimum condition, and accordingly, maximum laser energy can be obtained. Moreover, according to Embodiment 2, cost and volume can be reduced since the independent power source 110 is unnecessary unlike Embodiment 1.

5. Embodiment 3

5.1 Configuration

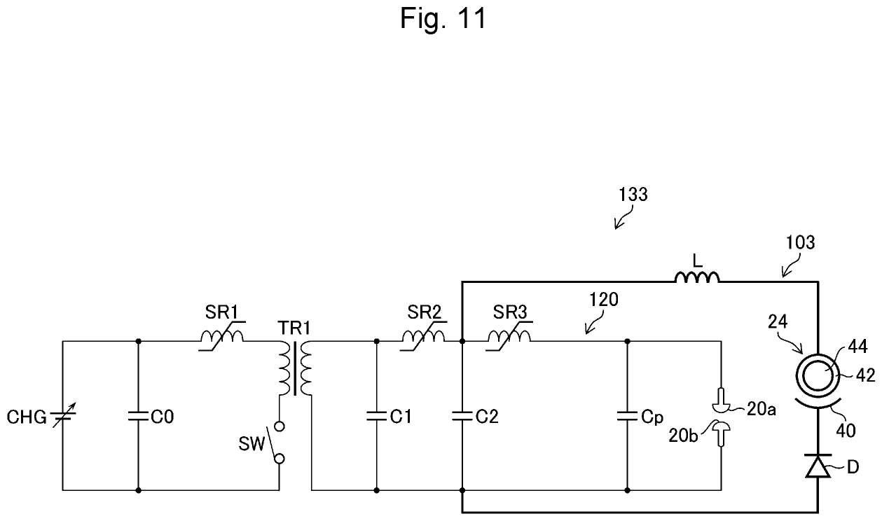

FIG. 11 is a circuit diagram of a pulse power generation device 133 including a pre-ionization circuit 103 and the main discharge circuit 120 applied to the gas laser apparatus 1 according to Embodiment 3. Description will be made on the difference of the configuration illustrated in FIG. 11 from the configuration illustrated in FIG. 9.

The pre-ionization circuit 103 of the pulse power generation device 133 used in Embodiment 3 has the configuration illustrated in FIG. 9 in which the magnetic switch SR4 is replaced with an inductor L, the pre-ionization capacitor Cc is omitted, and a diode D is connected in series to the inductor L and the corona pre-ionization electrode 24. The other configuration may be the same as in FIG. 9.

5.2 Operation

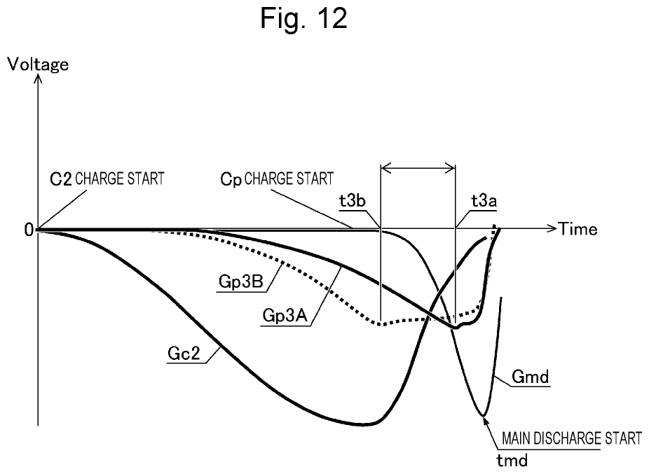

FIG. 12 is a graph illustrating temporal change of the pre-ionization voltage and the main discharge electrode voltage in the circuit illustrated in FIG. 11. In the drawing, graph Gp3A and graph Gp3B illustrated with a dashed line illustrate the pre-ionization voltage. Graph Gp3A corresponds to a case in which the inductance of the inductor L is large, and graph Gp3B corresponds to a case in which the inductance of the inductor L is small. Timing t3a is the start timing of the corona discharge when the inductance of the inductor L is large. Timing t3b is the start timing of the corona discharge when the inductance of the inductor L is small. As illustrated in FIG. 12, the start timing of the corona discharge changes in accordance with a designed value of the inductance of the inductor L.

Graph Gc2 illustrates voltage of the second capacitor C2. Since voltage application to the pre-ionization circuit 103 starts at start of charging of the second capacitor C2, the corona discharge can be started earlier than the circuit of the comparative example by designing the inductance of the inductor L to be small. Moreover, the rising speed of voltage can be changed in accordance with the magnitude of the inductance, and thus the corona discharge can be started at a desired timing.

As described above, circuits are designed to achieve such an optimum condition that the time interval Tcm between start of the corona discharge and start of the main discharge is 30 ns to 60 ns inclusive.

Moreover, the pre-ionization capacitor Cc is unnecessary since excessive voltage application to the corona pre-ionization electrode 24 can be prevented by the inductor L. However, the diode D is needed to prevent reverse voltage.

5.3 Effect

According to Embodiment 3, the time interval Tcm between start of the corona discharge and start of the main discharge can be set to the optimum condition, and accordingly, maximum laser energy can be obtained. Moreover, according to Embodiment 3, the magnetic switch SR4 in the configuration of Embodiment 2, which is expensive, is unnecessary, and thus cost can be reduced.

6. Embodiment 4

6.1 Configuration

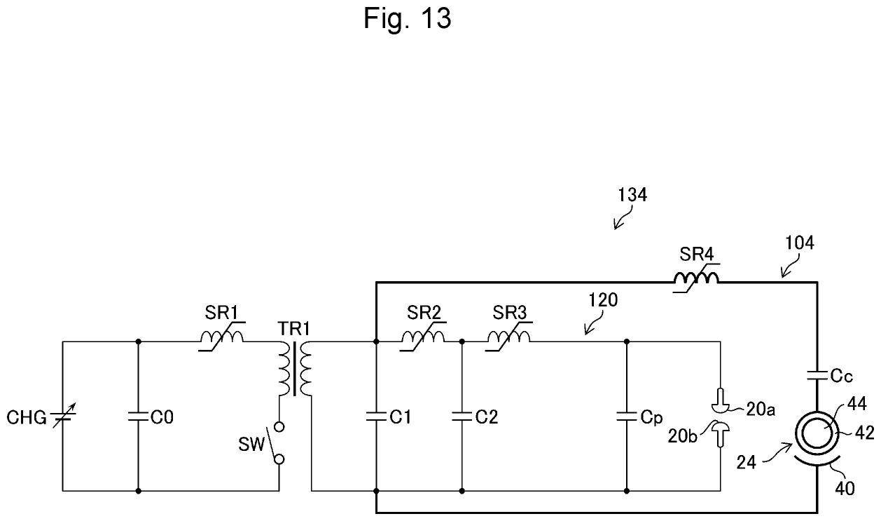

FIG. 13 is a circuit diagram of a pulse power generation device 134 including a pre-ionization circuit 104 and the main discharge circuit 120 applied to the gas laser apparatus 1 according to Embodiment 4. Description will be made on the difference of the configuration illustrated in FIG. 13 from the configuration illustrated in FIG. 9.

The pre-ionization circuit 102 illustrated in FIG. 9 is connected in parallel to the second capacitor C2, but in Embodiment 4 illustrated in FIG. 13, the pre-ionization circuit 104 in place of the pre-ionization circuit 102 in FIG. 9 is connected in parallel to the first capacitor C1.

Similarly to the pre-ionization circuit 102 in FIG. 9, the pre-ionization circuit 104 includes the magnetic switch SR4 and the pre-ionization capacitor Cc. Moreover, as a modification of FIG. 13, the magnetic switch SR4 and the pre-ionization capacitor Cc in the pre-ionization circuit 104 may be replaced with the inductor L and the diode D, respectively, as described above in Embodiment 3 (FIG. 11).

6.2 Operation

The circuit illustrated in FIG. 13 can start the corona discharge at a timing further earlier than the circuit illustrated in FIG. 9 by a time taken for energy transfer through the first capacitor C1, the magnetic switch SR2, and the second capacitor C2. Moreover, similarly to Embodiment 2, with the circuit illustrated in FIG. 13, it is possible to start the corona discharge at a desired timing by appropriately designing the number N of turns of the magnetic core of the magnetic switch SR4, the change ΔB in the magnetic flux density of the magnetic core, and the cross-sectional area S of the magnetic core.

6.3 Effect

According to Embodiment 4, the corona discharge can be started at a timing further earlier than in Embodiment 2. The configuration of Embodiment 4 is effective in a case in which, with the configuration of Embodiment 2, the time taken for transfer through the second capacitor C2 to the peaking capacitor Cp is extremely short and a desired value cannot be obtained for the time interval Tcm between start of the corona discharge and start of the main discharge.

7. Embodiment 5

7.1 Configuration

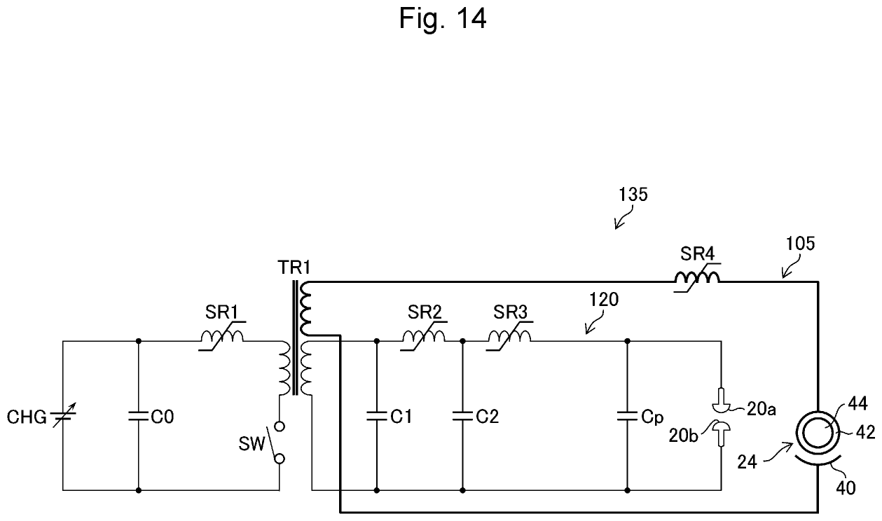

FIG. 14 is a circuit diagram of a pulse power generation device 135 including a pre-ionization circuit 105 and the main discharge circuit 120 applied to the gas laser apparatus 1 according to Embodiment 5. Description will be made on the difference of the configuration illustrated in FIG. 14 from the configuration illustrated in FIG. 13.

In Embodiment 5 illustrated in FIG. 14, the pre-ionization circuit 105 in place of the pre-ionization circuit 104 illustrated in FIG. 13 is connected to the step-up pulse transformer TR1. Specifically, the pre-ionization circuit 105 and the main discharge circuit 120 share the core of the step-up pulse transformer TR1 and are connected to the secondary side of the step-up pulse transformer TR1. In the pre-ionization circuit 105, the pre-ionization capacitor Cc is unnecessary.

7.2 Operation

Similarly to the circuit illustrated in FIG. 13 (Embodiment 4), the circuit illustrated in FIG. 14 can start the corona discharge at an earlier timing. Moreover, the voltage-dividing pre-ionization capacitor Cc can be omitted since the pre-ionization voltage can be adjusted by adjusting the turns ratio of the step-up pulse transformer TR1.

7.3 Effect

According to Embodiment 5, the same effect as in Embodiment 4 can be obtained, and furthermore, cost can be reduced since the pre-ionization capacitor Cc is unnecessary unlike Embodiment 4.

8. Embodiment 6

8.1 Configuration

The material of the dielectric pipe 42 is alumina ceramic in the examples described so far, but in Embodiment 6, the material of the dielectric pipe 42 is changed to a material such as sapphire having a dielectric strength higher than that of alumina ceramic. Since the dielectric strength is higher, it is possible to employ the dielectric pipe 42 having a smaller thickness accordingly. The other configuration may be the same as in FIG. 3, 7, 9, 11, 13, or 14.

8.2 Operation

Since the thickness of the dielectric pipe 42 is smaller, an electric field having a higher strength for the same voltage is generated between electrodes placed inside and outside the dielectric pipe 42. Accordingly, voltage at which the corona discharge starts decreases, and the corona discharge can be started at an earlier timing for the same rising timing of the pre-ionization voltage.

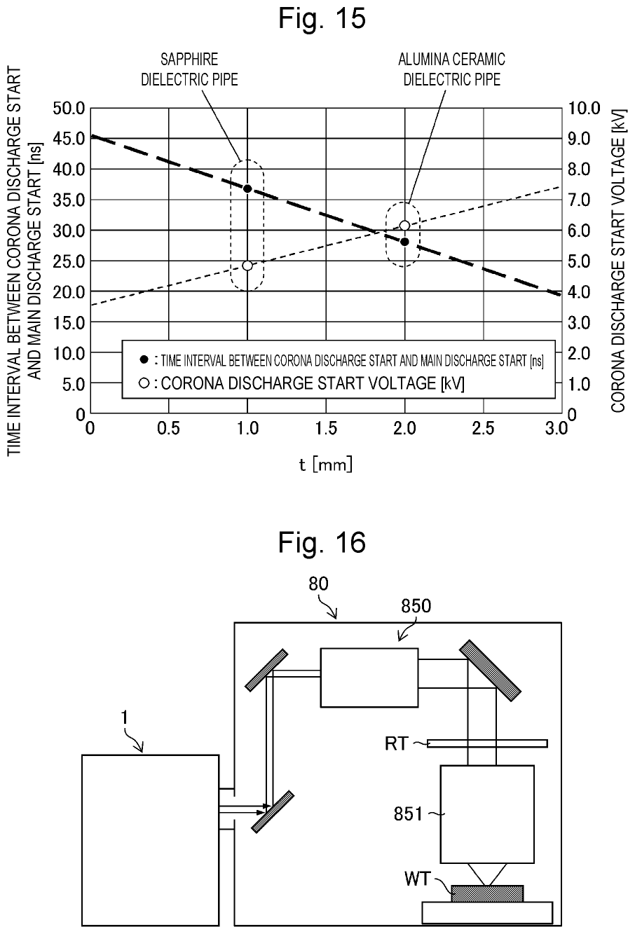

FIG. 15 illustrates the time interval Tcm between start of the corona discharge and start of the main discharge and the corona discharge start voltage for the thickness of the dielectric pipe 42 in the pre-ionization circuit 100 illustrated in FIG. 3. FIG. 15 indicates that it is possible to decrease the corona discharge start voltage and increase the time interval Tcm between start of the corona discharge and start of the main discharge by decreasing the thickness of the dielectric pipe 42.

The time interval Tcm between start of the corona discharge and start of the main discharge is approximately 28 ns in a case of an alumina ceramic dielectric pipe having a thickness of 2 mm. However, in a case in which a sapphire dielectric pipe having a thickness of 1 mm is used, the time interval Tcm between start of the corona discharge and start of the main discharge is approximately 37 ns, which satisfies the optimum condition.

8.3 Effect

The thickness of the dielectric pipe 42 can be decreased by forming the dielectric pipe 42 of a material having a dielectric strength higher than that of alumina ceramic, and accordingly, the time interval Tcm between start of the corona discharge and start of the main discharge can be increased. Thus, the time interval Tcm between start of the corona discharge and start of the main discharge can be set to the optimum condition, and accordingly, maximum laser energy can be obtained.

9. Electronic Device Manufacturing Method

FIG. 16 schematically illustrates an exemplary configuration of the exposure apparatus 80. The exposure apparatus 80 includes an illumination optical system 850 and a projection optical system 851. The illumination optical system 850 illuminates, with a laser beam incident from the gas laser apparatus 1, the reticle pattern of a non-illustrated reticle disposed on a reticle stage RT. The laser beam having transmitted through the reticle is imaged on a non-illustrated workpiece disposed on a workpiece table WT by reduced projection through the projection optical system 851. The workpiece is a photosensitive substrate such as a semiconductor wafer on which a photoresist is applied.

The exposure apparatus 80 translates the reticle stage RT and the workpiece table WT in synchronization to expose the workpiece to the laser beam on which the reticle pattern is reflected. The reticle pattern is transferred to the semiconductor wafer through the exposure process as described above, and then a plurality of processes are performed to manufacture a semiconductor device. The semiconductor device is an example of a an “electronic device” in the present disclosure.

10. Other

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A gas laser apparatus comprising:
a laser chamber into which laser gas is introduced;
a pair of main discharge electrodes disposed inside the laser chamber;
a pre-ionization electrode disposed inside the laser chamber;
a main discharge circuit connected to the main discharge electrodes and configured to supply, to the main discharge electrodes, main discharge voltage that causes main discharge; and
a pre-ionization circuit connected to the pre-ionization electrode and configured to supply, to the pre-ionization electrode, pre-ionization voltage that causes corona discharge,
the main discharge circuit including
a step-up pulse transformer,
a main capacitor and a switch that are connected to a primary side of the step-up pulse transformer,
a first power source connected to the main capacitor and configured to charge the main capacitor,
a first capacitor connected in parallel to a secondary side of the step-up pulse transformer,
a first magnetic switch connected to the first capacitor, and
a peaking capacitor connected in parallel to the first capacitor through the first magnetic switch and connected in parallel to the pair of main discharge electrodes,
an interval between a timing at which the corona discharge starts and a timing at which the main discharge starts being 30 ns to 60 ns inclusive.

2. The gas laser apparatus according to claim 1, further comprising a processor, wherein
the pre-ionization circuit includes a second power source that is different from the first power source,
the processor is configured to control the switch to cause the main discharge at a first timing and control the second power source to cause the corona discharge at a second timing earlier than the first timing, and
an interval between the first timing and the second timing is 30 ns to 60 ns inclusive.

3. The gas laser apparatus according to claim 2, further comprising a delay pulser to which a delay time for an ON signal that turns on the switch is set, wherein the ON signal is output from the processor and the ON signal delayed at the delay pulser is input to the second power source.

4. The gas laser apparatus according to claim 1, wherein
the main discharge circuit includes a second capacitor and a second magnetic switch,
the second capacitor is connected in parallel to the first capacitor through the first magnetic switch,
the second magnetic switch is connected in series to the first magnetic switch, and
the peaking capacitor is connected in parallel to the second capacitor through the second magnetic switch.

5. The gas laser apparatus according to claim 1, wherein the pre-ionization circuit is connected to the secondary side of the step-up pulse transformer.

6. The gas laser apparatus according to claim 5, wherein the pre-ionization circuit includes a third magnetic switch and a pre-ionization capacitor.

7. The gas laser apparatus according to claim 6, wherein the third magnetic switch, the pre-ionization capacitor, and the pre-ionization electrode are connected in series.

8. The gas laser apparatus according to claim 4, wherein
the pre-ionization circuit includes a pre-ionization capacitor and a third magnetic switch, the pre-ionization capacitor being connected in series to the pre-ionization electrode, the third magnetic switch being connected in series to the pre-ionization capacitor, and
the pre-ionization circuit is connected in parallel to the second capacitor.

9. The gas laser apparatus according to claim 5, wherein the pre-ionization circuit includes an inductor and a diode.

10. The gas laser apparatus according to claim 9, wherein the inductor, the pre-ionization electrode, and the diode are connected in series.

11. The gas laser apparatus according to claim 4, wherein
the pre-ionization circuit includes an inductor and a diode that are connected in series to the pre-ionization electrode, and
the pre-ionization circuit is connected in parallel to the second capacitor.

12. The gas laser apparatus according to claim 1, wherein
the pre-ionization circuit includes a pre-ionization capacitor and a third magnetic switch, the pre-ionization capacitor being connected in series to the pre-ionization electrode, the third magnetic switch being connected in series to the pre-ionization capacitor, and
the pre-ionization circuit is connected in parallel to the first capacitor.

13. The gas laser apparatus according to claim 1, wherein
the pre-ionization circuit includes an inductor and a diode that are connected in series to the pre-ionization electrode, and
the pre-ionization circuit is connected in parallel to the first capacitor.

14. The gas laser apparatus according to claim 1, wherein the pre-ionization circuit shares a core of the step-up pulse transformer with the main discharge circuit and is connected to the secondary side of the step-up pulse transformer.

15. The gas laser apparatus according to claim 14, wherein the pre-ionization circuit includes a third magnetic switch connected in series to the pre-ionization electrode.

16. The gas laser apparatus according to claim 1, wherein the pre-ionization electrode includes a dielectric, an internal electrode, and an external electrode, the dielectric having a pipe shape, the internal electrode being disposed inside the dielectric, the external electrode being disposed outside the dielectric.

17. The gas laser apparatus according to claim 16, wherein dielectric strength of a material of the dielectric is higher than dielectric strength of alumina ceramic.

18. The gas laser apparatus according to claim 16, wherein a material of the dielectric includes sapphire.

19. The gas laser apparatus according to claim 1, further comprising, on the primary side of the step-up pulse transformer, a magnetic assist that reduces a switching loss of the switch.

20. An electronic device manufacturing method comprising:
generating a laser beam with a gas laser apparatus, the gas laser apparatus including
a laser chamber into which laser gas is introduced,
a pair of main discharge electrodes disposed inside the laser chamber,
a pre-ionization electrode disposed inside the laser chamber,
a main discharge circuit connected to the main discharge electrodes and configured to supply, to the main discharge electrodes, main discharge voltage that causes main discharge, and
a pre-ionization circuit connected to the pre-ionization electrode and configured to supply, to the pre-ionization electrode, pre-ionization voltage that causes corona discharge,
the main discharge circuit including
a step-up pulse transformer,
a main capacitor and a switch that are connected to a primary side of the step-up pulse transformer,
a first power source connected to the main capacitor and configured to charge the main capacitor,
a first capacitor connected in parallel to a secondary side of the step-up pulse transformer,
a first magnetic switch connected to the first capacitor, and
a peaking capacitor connected in parallel to the first capacitor through the first magnetic switch and connected in parallel to the pair of main discharge electrodes,
an interval between a timing at which the corona discharge starts and a timing at which the main discharge starts being 30 ns to 60 ns inclusive;
outputting the laser beam to an exposure apparatus; and
exposing a photosensitive substrate to the laser beam in the exposure apparatus to manufacture an electronic device.
